(19) United States
(12) Patent Application Publication
(10) Pub. No.: US 2009/0320551 A1
(43) Pub. Date: Dec. 31, 2009

(54) Thread rolling die

(75) Inventor: Akihiko Ogura, Toyokawa-shi (JP)

Correspondence Address: OLIFF & BERRIDGE, PLC, P.O. BOX 320850, ALEXANDRIA, VA, 22320-4850, US

(73) Assignee: OSG CORPORATION, TOYOKAWA-SHI (JP)

(21) Appl. No.: 12/457,533

(22) Filed: Jun. 15, 2009

(30) Foreign Application Priority Data
Jun. 26, 2008 (JP) 2008-167361

(51) Int. Cl. B23G 5/04; B21H 3/06

(52) U.S. Cl. 72/469; 72/88

(57) ABSTRACT

A thread rolling die having a nitride diffusion layer formed in a surface layer portion of a form rolling surface portion for thread rolling to plastically deform a surface of a workpiece, the nitride diffusion layer being formed in an ion nitriding treatment such that a compound layer depth is 1 μm or smaller, a practical nitride layer depth ranges from 5 to 40 μm, and either of that a surface hardness is 1300 HV or larger or that a surface hardened amount is 400 HV or larger.

This application is based on the Japanese Patent Application No. 2008-167361 filed Jun. 26, 2008, the contents of which are incorporated hereinto by reference.

### BACKGROUND OF THE INVENTION

1. Field of the Invention

The present invention relates to a thread rolling die, particularly, to technique that permits to restrain chipping or fracturing of the form rolling surface and to have superior abrasive resistance and durability due to the surface hardness.

2. Description of Related Art

A thread rolling die having a nitride diffusion layer formed on a form rolling surface portion and used for rolling to plastically deform (by being pressed on) a surface of a workpiece is spread for rolling such as threads, gears and splines. Such a rolling die is in general made by forming the nitride diffusion layer on the surface portion of a base made of such as alloy tool steel (SKD) or high-speed tool steel (SKH) defined in the Japanese Industrial Standards (JIS), by such as a salt-bath nitriding or gas nitriding treatment. And JP 2002-192282 A discloses technique to form the nitride diffusion layer by an ion nitriding treatment.

However, such a conventional thread rolling die has a disadvantage that a hard and fragile compound layer made of such as a nitride formed on the surface of the nitride diffusion layer, causes inferiority in abrasive resistance and durability due to tendency to generate chippings and fracturings instead of increasing in the surface hardness. That is, the hard and fragile compound layer cannot cause an expected improvement in abrasive resistance and durability. Especially, in the salt-bath nitriding or gas nitriding treatment, an attempt for the desired the surface hardness causes thick nitride diffusion layer and an increase in hardness within and, then, reduction in toughness and fragileness. It also tends to generate fracturing.

It is therefore an object of the present invention to provide an improvement of a thread rolling die that is durable by restraining chipping and fracturing derived from reduction in toughness or the characteristics of a compound layer, for a form rolling surface of the thread rolling die to be hardened by nitriding for improvement in abrasive resistance.

### SUMMARY OF THE INVENTION

The object indicated above may be achieved according to a first mode of the invention, which provides a thread rolling die having a nitride diffusion layer formed in a surface layer portion of a form rolling surface portion for thread rolling to plastically deform a surface of a workpiece, the nitride diffusion layer being formed in the ion nitriding treatment such that a compound layer depth is 1 μm or smaller, a practical nitride layer depth (or practical depth t1 of the nitride layer) ranges from 5 to 40 μm, and either of that a surface hardness is 1300 HV or larger or that a surface hardened amount is 400 HV or larger.

The compound layer depth and the practical nitride layer depth are defined in “Method of measuring nitrided case depth for iron and steel” in the code of G 0562 (1993) of the Japanese Industrial Standards (JIS). The compound layer depth is a depth from the surface to a layer mainly made of such as nitride, carbide or carbon nitride, and the practical nitride layer depth is a depth from the surface of the nitride layer to a point where its hardness is 50 (HV or HK) higher than the value of Vickers or Knoop hardness of the base material.

The surface hardened amount is a difference between the value of the surface hardness and the value of Vickers or Knoop hardness of the base material.

The object indicated above may be achieved according to a second mode of the invention, which provides the thread rolling die of the first mode of the invention, the nitride diffusion layer being formed on a surface of a base of a tool in the ion nitriding treatment, without being modified in another treatment.

The object indicated above may be achieved according to a third mode of the invention, which provides the thread rolling die of the first or second mode of the invention, including an oxidized layer ranging from 1 to 5 μm in thickness and formed on the nitride diffusion layer in an oxidizing treatment, without being modified in another treatment.

Upon forming the nitride diffusion layer in the ion nitriding treatment, the compound layer depth and the practical nitride layer depth can be varied by conditions, for instance, such as a ratio of nitrogen to hydrogen gases and a pressure of the mood gas, the temperature and the duration of the treatment. Then, the relationships between the deflective strength or abraded amount and the compound layer depth and practical nitride layer depth were sought by measuring with various compound layer depths and practical nitride layer depths given in the aforementioned manner. As a result, superiority in deflective strength and abrasive resistance with reduction in the abraded amount was achieved when the compound layer depth was 1 μm or smaller and the practical nitride layer depth ranges from 5 to 40 μm. It is inferred that the nitride diffusion layer is not substantially affected by the hard and fragile compound layer due to the compound layer depth of 1 μm or smaller, and the practical nitride layer depth of 40 μm or smaller and being comparatively shallow, causes the nitride diffusion layer to preferably maintain toughness, and, furthermore, the multiplier effect of them may achieve superiority in deflective strength, that is, fracturing resistance. The practical nitride layer depth of 5 μm or larger is necessary for a surface hardness or surface hardened amount to achieve superiority in abrasive resistance upon form rolling. The aforementioned conditions to provide the surface hardness of 1300 HV or larger or the surface hardened amount of 400 HV or larger cause superiority in abrasive resistance along with restraining early generation of chipping and fracturing on the thread rolling die, to provide considerably improvement in durability.

Since the third mode of the invention provides the thread rolling die having an oxidized layer ranging from 1 to 5 μm in thickness formed on the nitride diffusion layer in an oxidizing treatment, the oxidized layer improves capability of retaining a lubricant, and, accordingly, it provides improvement in capability of lubrication and seizure resistance, to achieve further superiority in abrasive resistance and durability.

The present invention may be applied to a various rolling dies such as a cylindrical die, a flat die and a planetary die. A thread rolling die is well-known, however, it may be also applied to a rolling die for rolling various members except a screw such as a gear or spline. Tool steel such as alloy tool steel or high-speed tool steel may be preferably used for the rolling die (the base of the tool).

Although in the aforementioned ion nitriding treatment a mixture gas of nitrogen gas (N₂) and hydrogen gas (H₂) is used, ammonia (NH₃) may be used in the ion nitriding treatment. A steam oxidation treatment is, for instance, preferably used to form the oxidized layer, however, any other oxidation treatments may be used.

In the present invention, it is preferable that the nitride diffusion layer is formed on the surface of the base of the tool in the ion nitriding treatment without in any other modifying treatment such as shot peening, and the oxidized layer is formed on the nitride diffusion layer in the oxidizing treatment without in any other modifying treatment such as shot peening.

### BRIEF DESCRIPTION OF THE DRAWINGS

FIGS. 1A and 1B illustrate a cylindrical rolling die of an embodiment according to the present invention, FIG. 1A illustrates the die in a perspective view and FIG. 1B illustrates a part of a surface portion in a sectional view.

FIGS. 2A, 2B and 2C illustrate the compound layer formed on the surface of the nitride diffusion layer to show its depth, about 0 μm in FIG. 2A, about 1 μm in FIG. 2B and about 5 μm in FIG. 2C, prepared on the basis of electron micrographs.

FIG. 3A illustrates conditions for the experimentations for durability by thread rolling with the present invention and conventional die and FIG. 3B illustrates the results.

FIGS. 4A and 4B illustrate surface modifying treatments of the present invention and conventional die used in the experimentations in FIGS. 3A and 3B in flowcharts.

FIG. 5 illustrates a graph indicating hardness after the ion nitriding treatment in S1 of FIG. 4A and hardness after the salt-bath nitriding treatment in R1 of FIG. 4B.

FIG. 6A illustrates a graph indicating the relationship of the deflective strength and compound layer depth and FIG. 6B illustrates a graph indicating the relationship of the deflective strength and practical nitride layer depth.

FIG. 7A illustrates a graph indicating the relationship of the abraded amount and compound layer depth and FIG. 7B illustrates a graph indicating the relationship of the abraded amount and practical nitride layer depth.

### DETAILED DESCRIPTION OF EXEMPLARY EMBODIMENTS

Hereinafter, there will be described the present invention by reference to the drawings. The figures are appropriately simplified or transformed, and all the proportion of the dimension and the shape of a portion or member may not be reflective of the real one in the following embodiments.

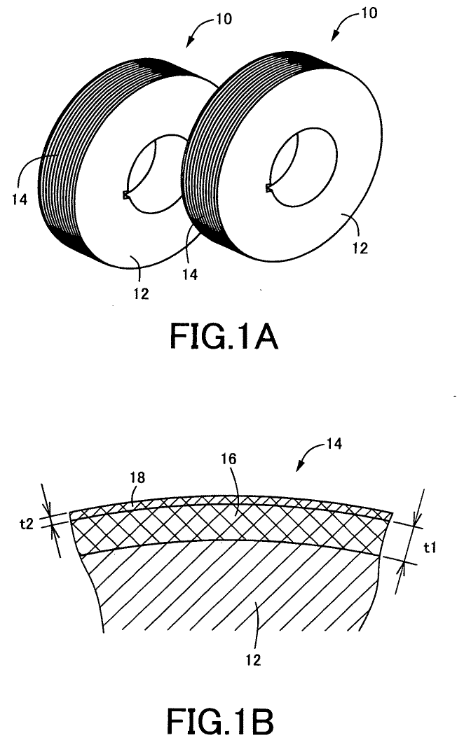

FIG. 1A illustrates a pair of thread rolling cylindrical dies 10 of an embodiment according to the present invention in a perspective view. FIG. 1B illustrates a part of a circumferential portion of the thread rolling cylindrical die shown in FIG. 1A in a sectional view. A pair of the thread rolling cylindrical dies 10 forms a unit in a practical scene. A base 12 of a tool is made of alloy tool steel (SKD) defined in the Japanese Industrial Standards (JIS) and a plurality of ridges of threads are formed on a form rolling surface (portion) 14 in the circumferential portion such that the ridges of threads are complementarily formed to thread grooves to be formed on a surface of a cylindrical workpiece (material for a screw) in a sectional view upon being cut along an axial direction. That is, a thread on the workpiece is formed by pressing the ridged threads on the surface of the cylindrical workpiece and rolling.

The aforementioned form rolling surface (portion) 14 is treated by the ion nitriding treatment without being modified by another treatment such as shot peening, and a nitride diffusion layer 16 is formed on the form rolling surface (portion) 14 such that nitrogens are diffused in the nitride diffusion layer 16 in the surface layer portion of the form rolling surface (portion) 14. In the ion nitriding treatment, glow discharge is generated in a vacuum furnace, and nitrogens are impregnated and diffused in the base 12 in a mixture mood of nitrogen and hydrogen. In this embodiment, conditions such as a gas pressure, a ratio between gases in a mixture and duration of a nitriding treatment are determined such that the nitride diffusion layer 16 having a practical nitride layer depth t1 in the range of 5 to 40 μm, and surface hardness of 1300 HV or larger or the surface hardened amount of 400 HV or larger, is formed. Restraining chipping and fracturing by preferably maintaining toughness inside the layer 16 due to comparative shallowness of 40 μm or smaller in the practical nitride layer depth t1, 5 μm or larger in the practical nitride layer depth t1, and 1300 HV or larger in surface hardness or 400 HV or larger of the surface hardened amount, cause superiority in abrasive resistance.

In the aforementioned ion nitriding treatment, a compound layer made of such as nitride on the surface is formed as a result of a reaction of nitrogen and such as iron in the base 12, and in this embodiment, conditions are determined such that the compound layer depth is 1 μm or smaller. Such a compound layer causes chipping or fracturing due to its hardness and fragility. However, in this embodiment, since the compound layer depth is 1 μm or smaller, chipping or fracturing derived from the compound layer is restrained. The compound layer depth depends upon the duration of the ion nitriding treatment, and the duration is fundamentally determined in accordance with the practical nitride layer depth t1, and also altering the mixing ratio of nitrogen gas (N₂) to hydrogen gas (H₂) permits regulation of the compound layer depth.

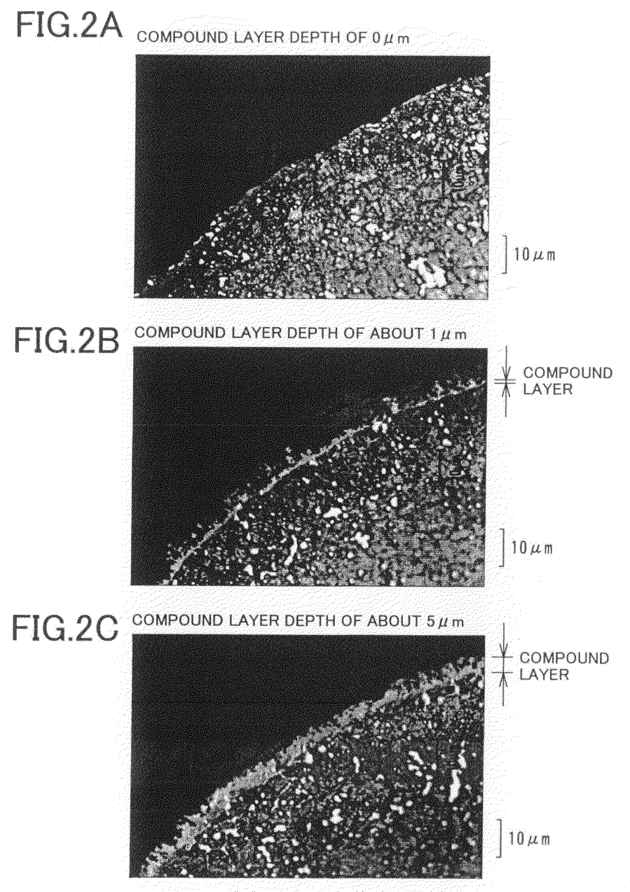

FIGS. 2A, 2B and 2C illustrate a part of the surface portion in the sectional view, based upon electron micrographs. The compound layer depths in FIGS. 2A, 2B and 2C are, respectively, about 0 μm, about 1 μm and about 5 μm. White portions called “white layers” correspond to the compound layers and they are distinguishable and convenient upon measuring the depth.

The form rolling surface portion 14 in which the nitride diffusion layer 16 is formed by the aforementioned ion nitriding treatment, is treated in the steam oxidizing treatment without being modified by another treatment such as shot peening to form an oxidized layer 18. In the steam oxidizing treatment, the thread rolling cylindrical die 10 is heated in the water vapor (or steam) mood at about 500° C., to form the oxidized layer 18 on the surface of the form rolling surface portion 14. In this embodiment, conditions such as the heating temperature and duration of the treatment are determined such that the oxidized layer 18 ranging from 1 to 5 μm in thickness is formed. This formed oxidized layer 18 is made of porous triiron tetroxide that is generated in a reaction of oxygen and iron in the base 12, and it provides superiority in lubricity due to lubricating oil preferably preserved in pores of the oxidized layer 18.

In this embodiment, the thread rolling cylindrical die 10 is synergistically provided with superiority in deflective strength, by that the die 10 is not so affected by the hard and fragile compound layer because the compound layer depth of the compound layer that is formed on the surface of the nitride diffusion layer 16 is 1 μm or smaller, and by that inside toughness is preferably maintained because the practical nitride layer depth t1 is 40 μm or smaller and comparatively shallow. Furthermore, the die 10 is improved in durability by restraining early chipping and fracturing of the rolling die 10 and by excellent abrasive resistance, due to 5 μm or larger of the practical nitride layer depth t1, and 1300 HV or larger in surface hardness or 400 HV or larger of the surface hardened amount, in addition to the aforementioned improvement in deflective strength.

In this embodiment, since the oxidized layer 18 ranging from 1 to 5 μm in thickness is formed on the nitride diffusion layer 16 in the steam oxidizing treatment, the oxidized layer 18 provides improvement in characteristics of maintaining the lubricating oil, then, improvement in lubrication characteristics and anti-seizing property to provide further superiority in abrasive resistance and durability.

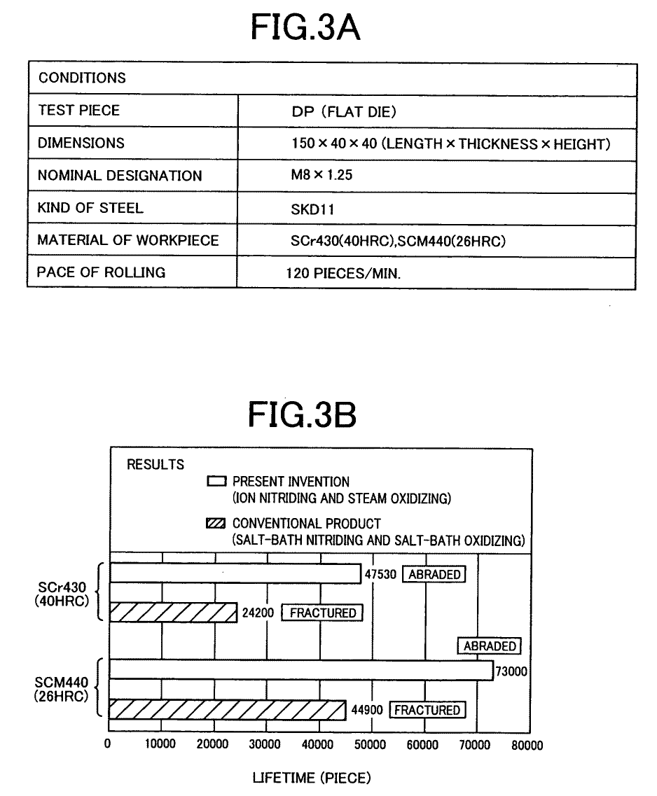

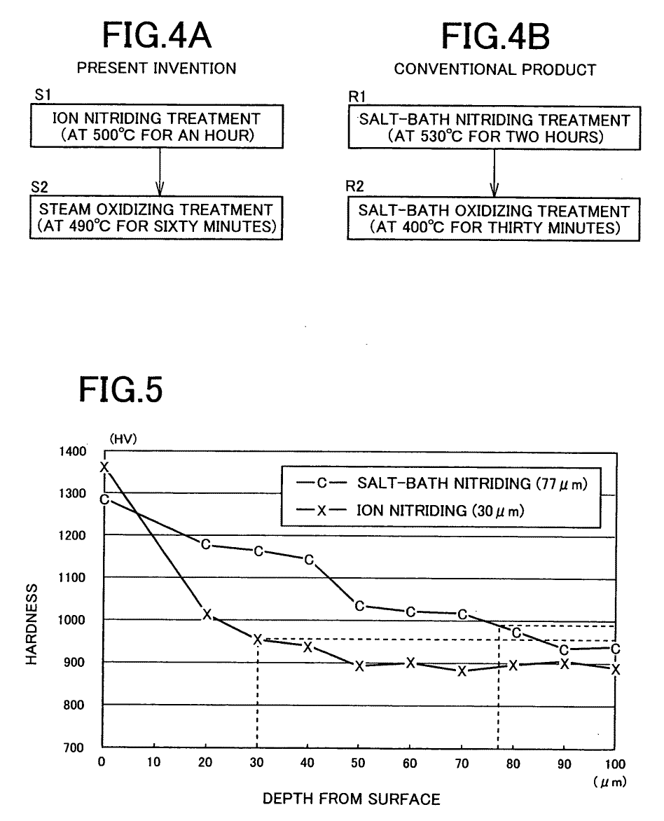

FIGS. 3A and 3B show conditions and results, respectively, for thread rolling tests for durability, for the present invention of a die plate (or flat die) for thread rolling and the conventional die (or product), prepared in steps shown in FIGS. 4A and 4B, respectively. The present invention is prepared by a surface treatment (in ion nitriding and steam oxidizing treatment) on the form rolling surface (portion) 14 in the steps in FIG. 4A, and the conventional die is prepared by another surface treatment (in salt-bath nitriding and salt-bath oxidizing treatment) on the form rolling surface (portion) 14 in the steps in FIG. 4B. The materials SCr430 and SCM440 for rolled workpieces are made of chrome steel and chromium-molybdenum steel, respectively, defined in the Japanese Industrial Standards (JIS).

For the present invention, the nitride diffusion layer 16 having about 30 μm of the practical nitride layer depth t1 and about 1357 HV of the surface hardness (HV 0.3) (about 425 HV of the surface hardened amount), is formed in the ion nitriding treatment in the step S1 of FIG. 4A. The graph with signs “X” in FIG. 5 indicates the relationship of the hardness and the depth from the surface of the nitride diffusion layer 16 formed in the aforementioned ion nitriding treatment, and the graph with signs “C” indicates the relationship for the nitride diffusion layer 16 formed in the salt-bath nitriding treatment in the step R1 of FIG. 4B. The ion nitriding treatment provides superiority in hardness with maintaining the inside toughness upon hardening the surface, as, although the graph indicates about 30 μm of the practical nitride layer depth t1, it indicates about 1357 HV of the surface hardness nevertheless. However, the salt-bath nitriding treatment provides inferiority in toughness due to hardening into the inside, to generate such as fracturing upon rolling, as the graph indicates about 77 μm of the practical nitride layer depth t1, even though the surface hardness is 1300 HV or smaller. In FIG. 5, the standard hardness (a Vickers hardness value of base material plus 50) for the salt-bath nitriding treatment for the practical nitride layer depth t1 is larger than that for the ion nitriding treatment, due to individual differences among the materials 12 or dispersion upon measuring.

The compound layer depth is regulated by changing the ratio of nitrogen gas (N₂) to hydrogen gas (H₂) in a mixture upon the ion nitriding treatment. In the present embodiment, the compound layer depth is regulated at about 0.3 μm by setting the ratio of N₂:H₂ equal to about 1:1. In the step S2 in FIG. 4A, the oxidized layer 18 having about 2 μm of the aforementioned layer thickness t2 is formed in the steam oxidizing treatment at about 490° C. for about sixty minutes.

For the conventional product, the nitride diffusion layer 16 is formed by the salt-bath nitriding treatment and the oxidized layer 18 is formed by salt-bath oxidizing treatment as shown in FIG. 4B.

By rolling using the aforementioned present invention and conventional product in the conditions listed in FIG. 3A, the lifetime of them were measured. The lifetime expired when the diameter of the thread was larger than a hole of a thread ring gauge (GR) due to abrasion of the die and the thread could not pass through the hole, or when a fracture was generated on the die. The lifetime is represented by pieces of the rolled thread. The graphs in FIG. 3B apparently show that the die according to the present invention rolling the workpiece of SCr 430 (40 HRC) has about twice as long in durability as the conventional die, and that the die according to the present invention rolling the workpiece of SCM 440 (26 HRC) has about 1.6 times as long in durability as the conventional die. It is found that the die according to the present invention causes improvement in durability with both of the workpieces.

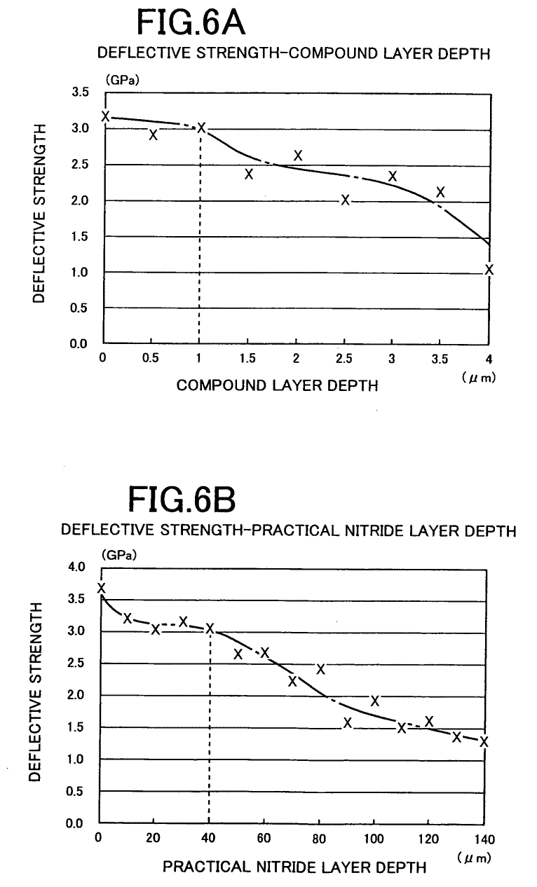

FIG. 6A shows the relationship between the deflective strength and compound layer depth. The deflective strength of a sample is measured in the bending strength test defined in JIS (Japanese Industrial Standards) R1601, after preparing various samples in the compound layer depth by such as changing the ratio of nitrogen gas (N₂) to hydrogen (H₂) in the mixture in the ion nitriding treatment. The graph in FIG. 6A indicates about 3 GPa in the deflective strength at and within 1 μm of the compound layer depth, and indicates a smaller value of the deflective strength over the depth of 1 μm (that is, deeper than 1 μm) and shows a steeply descent tendency. The sample is made of alloy tool steel (SKD) and has a shape of a rectangular parallelepiped having dimensions of 5×4×10 mm, on which the nitriding treated layers are wholly formed, the surface hardness of each of the nitride diffusion layer ranges from 1358 to 1369 HV, the practical nitride layer depth is about 30 μm, and the oxidized layer is about 2 μm in thickness.

FIG. 6B shows the relationship between the deflective strength and the practical nitride layer depth. The deflective strength of a sample is measured in the same manner as the aforementioned measurement, after preparing various samples in the practical nitride layer depth by such as changing the duration of the ion nitriding treatment. The graph in FIG. 6B indicates about 3 GPa in the deflective strength at and within 40 μm of the practical nitride layer depth, and indicates a smaller value of the deflective strength over the depth of 40 μm (that is, deeper than 40 μm) and shows a steeply descent tendency. The surface hardness of each of the nitride diffusion layer of the sample ranges from 1358 to 1369 HV, the compound layer depth is about 0.3 μm, and the oxidized layer is about 2 μm in thickness. Therefore, FIGS. 6A and 6B show that high value of about 3 GPa or larger in the deflective strength can be achieved when the compound layer depth is 1 μm or smaller and the practical nitride layer depth is 40 μm or smaller.

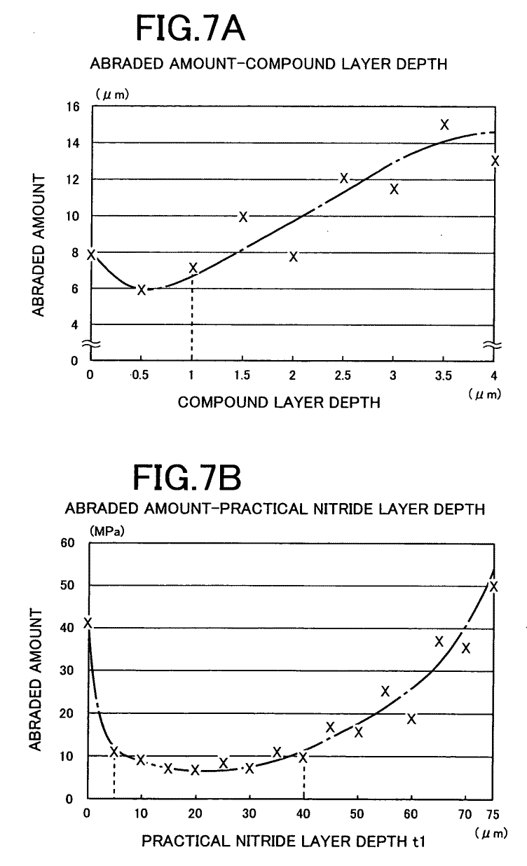

FIG. 7A shows the relationship between the abraded amount and compound layer depth. The abraded amount (amount of reduction in height) of the crest of the thread ridge on the form rolling surface 14 of a sample of the flat die is measured after preparing various samples in the compound layer depth by such as changing the ratio of nitrogen gas (N₂) to hydrogen gas (H₂) in the mixture in the ion nitriding treatment, and, then, rolling 10000 (ten thousands of) workpieces of SCM 440 (26 HRC) in the same condition for the test as that in FIG. 3A. The samples are the same thread rolling flat dies as those used in the test for durability in FIG. 3A. The graph in FIG. 7A indicates about 8 μm or smaller in the abraded amount when the compound layer depth is 1 μm or smaller, and indicates a larger value in the abraded amount when the compound layer depth is over 1 μm (that is, deeper than 1 μm) and shows an ascent tendency with generating frequent chipping. The surface hardness of the nitride diffusion layer 16 of each of the sample ranges from 1358 to 1369 HV, the practical nitride layer depth t1 is about 30 μm, and the thickness t2 of the oxidized layer 18 is about 2 μm.

FIG. 7B shows the relationship between the abraded amount and the practical nitride layer depth t1. The abraded amount of a sample of the flat die is measured in the same manner as the aforementioned measurement, after preparing various samples in the practical nitride layer depth t1 by such as changing the duration of the ion nitriding treatment. The graph in FIG. 7B indicates about 12 μm or smaller of the abraded amount when the practical nitride layer depth t1 ranges from 5 μm to 40 μm, and indicates a larger value of the abraded amount when the practical nitride layer depth is over 40 μm (that is, deeper than 40 μm) and shows a steeply ascent tendency with generating frequent chipping. That is, a shallower practical nitride layer depth t1 than 5 μm causes reduction in abrasive resistance due to insufficient surface hardness, and a deeper practical nitride layer depth t1 than 40 μm causes reduction in abrasive resistance due to reduction in toughness to be fragile and tend to generate fracturing. The surface hardness of each of the nitride diffusion layer of the sample (excluding those of 0 μm of the practical nitride layer depth t1) ranges from 1358 to 1369 HV, the compound layer depth is about 0.3 μm, and the thickness t2 of the oxidized layer 18 is about 2 μm. Therefore, FIGS. 7A and 7B show that the practical nitride layer depth t1 considerably affects the abraded amount, and the practical nitride layer depth t1 ranging from 5 to 40 μm can provide superior abrasive resistance with the abraded amount of about 12 μm or smaller.

Accordingly, FIGS. 6A, 6B, 7A and 7B show that forming the nitride diffusion layer 16 having the compound layer depth of 1 μm or smaller and the practical nitride layer depth t1 ranging from 5 to 40 μm can provide superior abrasive resistance with restraining generation of chipping and fracturing.

It is to be understood that the present invention may be embodied with other changes, improvements, and modifications that may occur to a person skilled in the art without departing from the scope and spirit of the invention defined in the appended claims.

What is claimed is:

1. A thread rolling die having a nitride diffusion layer formed in a surface layer portion of a form rolling surface portion for thread rolling to plastically deform a surface of a workpiece,
the nitride diffusion layer being formed in an ion nitriding treatment such that a compound layer depth is 1 μm or smaller, a practical nitride layer depth ranges from 5 to 40 μm, and either of that a surface hardness is 1300 HV or larger or that a surface hardened amount is 400 HV or larger.

2. The thread rolling die of claim 1, the nitride diffusion layer being formed on a surface of a base of a tool in the ion nitriding treatment, without being modified in another treatment.

3. The thread rolling die of claim 1, comprising an oxidized layer ranging from 1 to 5 μm in thickness and formed on the nitride diffusion layer in an oxidizing treatment, without being modified in another treatment.
